(19) United States
(12) Patent Application Publication
(10) Pub. No.: US 2007/0113904 A1
(43) Pub. Date: May 24, 2007

(54) High-pressure fuel pump

(75) Inventor: Katsunori Furuta, Obu-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/600,838

(22) Filed: Nov. 17, 2006

(30) Foreign Application Priority Data
Nov. 21, 2005 (JP) 2005-335367
Sep. 14, 2006 (JP) 2006-249139

(51) Int. Cl. F16K 15/00

(52) U.S. Cl. 137/540

(57) ABSTRACT

A discharge valve is provided in a discharge section integrally formed with a housing main body. A spring seat member of the discharge valve is accommodated inside a discharge passage defined by the discharge section. Movement of the spring seat member accommodated in the housing main body is restricted by a ring, and the spring seat member is held by the housing main body. Thus, binding between the housing main body and the discharge section is unnecessary, and a sealing member to be provided between the housing main body and the discharge section for preventing fuel leak is unnecessary. The spring seat member is formed in a cylindrical shape with a first passage and a second passage. Thus, a passage, through which the fuel pressurized in the pressurization chamber flows, is ensured.

### CROSS REFERENCE TO RELATED APPLICATION

This application is based on and incorporates herein by reference Japanese Patent Application No. 2005-335367 filed on Nov. 21, 2005 and Japanese Patent Application No. 2006-249139 filed on Sep. 14, 2006.

### BACKGROUND OF THE INVENTION

1. Field of the Invention

The present invention relates to a high-pressure fuel pump that pressurizes fuel suctioned into a pressurization chamber through reciprocating movement of a plunger.

2. Description of Related Art

A conventional high-pressure fuel pump 110 shown in FIG. 8, for example, as described in JP-A-2002-195128, has a discharge valve 112 on an outlet side of a pressurization chamber, which pressurizes fuel, for opening and closing a discharge passage 111. The discharge valve 112 of the high-pressure fuel pump 110 has a spring 115, a spring seat 116, a valve holder 117 and the like. The spring 115 pushes a valve member 113 toward a valve seat 114. The spring seat 116 holds an end of the spring 115. The valve holder 117 fixes the spring 115 and the spring seat 116 to a housing 120. The spring 115 and the spring seat 116 are accommodated inside the valve holder 117. The valve holder 117 has a threaded portion 118 bonded with the housing 120 through thread connection. The valve holder 117 is fixed to the housing 120 by screwing the threaded portion 118.

The high-pressure fuel pump 110 described in JP-A-2002-195128 needs the separate spring seat 116 and valve holder 117. Moreover, a gasket 121 or the like has to be located between the valve holder 117 and the housing 120 to prevent leakage of the high-pressure fuel. Accordingly, the number of the components is increased. Since the valve holder 117 is screwed to the housing 120, the body size of the high-pressure fuel pump 110 is enlarged.

### SUMMARY OF THE INVENTION

It is an object of the present invention to provide a high-pressure fuel pump having a reduced number of components and a reduced body size.

According to an aspect of the present invention, a discharge section providing a discharge passage is integrally formed with a housing. Thus, the structure of the housing and the discharge section is simplified. Since the housing and the discharge section are formed integrally, a sealing member for preventing the leakage of the fuel is unnecessary. Accordingly, the number of components can be reduced significantly.

Since the discharge section and the housing are integrally formed, a portion for connecting the discharge section to the housing is reduced. Accordingly, the structure around the discharge section is simplified, reducing the number of components. Thus, the body size can be reduced.

### BRIEF DESCRIPTION OF THE DRAWINGS

Features and advantages of embodiments will be appreciated, as well as methods of operation and the function of the related parts, from a study of the following detailed description, the appended claims, and the drawings, all of which form a part of this application. In the drawings:

FIG. 1 is a sectional diagram showing a high-pressure fuel pump according to a first example embodiment of the present invention;

FIG. 2 is a sectional diagram showing a discharge section of the high-pressure fuel pump according to the FIG. 1 embodiment;

FIG. 3 is a diagram showing a relationship between a position and a sectional area of a discharge passage of the high-pressure fuel pump according to the FIG. 1 embodiment;

FIG. 4 is a sectional diagram showing a discharge section of a high-pressure fuel pump according to a second example embodiment of the present invention;

FIG. 5 is a sectional diagram showing a discharge section of a high-pressure fuel pump according to a third example embodiment of the present invention;

FIG. 6 is a sectional diagram showing a discharge section of a high-pressure fuel pump according to a fourth example embodiment of the present invention;

FIG. 7 is a sectional diagram showing a discharge section of a high-pressure fuel pump according to a fifth example embodiment of the present invention; and

FIG. 8 is a sectional diagram showing a high-pressure fuel pump of a related art.

### DETAILED DESCRIPTION OF EXAMPLE EMBODIMENTS

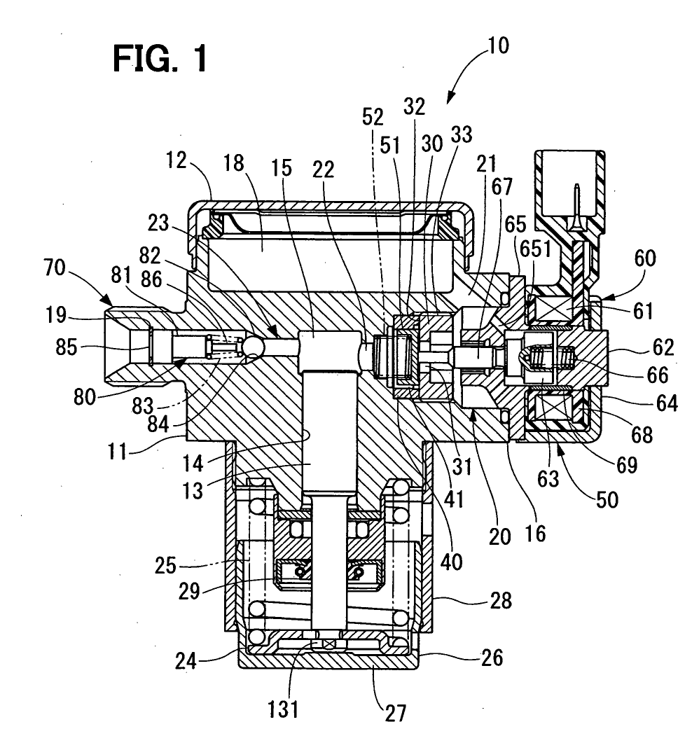

Referring to FIG. 1, a high-pressure fuel pump according to a first example embodiment of the present invention is illustrated. The high-pressure fuel pump 10 is a fuel supply pump for supplying fuel to an injector of a diesel engine or a gasoline engine, for example. As shown in FIG. 1, the high-pressure fuel pump 10 has a housing main body 11, a cover 12, a plunger 13, a metering valve section 50, a discharge section 70 and the like. The housing main body 11 is made of stainless steel of the martensite family, for example. The housing main body 11 provides a cylinder 14. The plunger 13 is held in the cylinder 14 of the housing main body 11 such that the plunger 13 can reciprocate in its axial direction.

The housing main body 11 provides an introduction passage 21, a suction passage 22, a pressurization chamber 15, a discharge passage 23 and the like. The housing main body 11 is formed with a cylinder portion 16. The cylinder portion 16 is formed substantially in a cylindrical shape and defines a communication hole section 20 therein for providing communication between the introduction passage 21 and the suction passage 22. The cylinder portion 16 is formed substantially perpendicularly to the cylinder 14 such that an internal diameter of the cylinder portion 16 changes at certain midpoints. The cylinder portion 16 accommodates a seat member 30 and a guide member 40.

A fuel chamber 18 is formed between the housing main body 11 and the cover 12. The fuel is supplied to the fuel chamber 18 from a fuel tank (not shown) by a fuel pump (not shown). The introduction passage 21 connects the fuel chamber 18 with the communication hole section 20 formed on an inner peripheral side of the cylinder portion 16. An end of the suction passage 22 communicates with the pressurization chamber 15. The other end of the suction passage 22 communicates with the communication hole section 20. The introduction passage 21 communicates with the suction passage 22 through the communication hole section 20, a communication hole 31 formed on an inner peripheral side of the seat member 30 and a groove 41 formed on the guide member 40. Thus, the fuel chamber 18 can communicate with the pressurization chamber 15 through the introduction passage 21, the communication hole section 20 of the housing main body 11, the communication hole 31 of the seat member 30, the groove 41 of the guide member 40 and the suction passage 22.

The plunger 13 is held in the cylinder 14 of the housing main body 11 such that the plunger 13 can reciprocate in the axial direction. The pressurization chamber 15 is formed on an end side of the plunger 13 with respect to the direction of the reciprocating movement. A head 131 formed on the other end side of the plunger 13 is bonded with a spring seat 24. A spring 25 as a resilient member is provided between the spring seat 24 and the housing main body 11. The spring seat 24 is pressed against an inner wall of a bottom section 27 of a tappet 26 by a pressing force of the spring 25. An outer wall of the bottom section 27 of the tappet 26 contacts a cam (not shown) to drive the plunger 13 to reciprocate in the axial direction. The movement of the tappet 26 is guided by a tappet guide 28. The tappet guide 28 is located on an outer peripheral side of the cylinder 14 of the housing main body 11.

An oil seal 29 seals a space between the outer peripheral face of the plunger 13 on the head 131 side and the inner peripheral face of the housing main body 11, which provides the cylinder 14 accommodating the plunger 13. The oil seal 29 prevents intrusion of oil from an inside of the engine into the pressurization chamber 15 and prevents leakage of the fuel from the pressurization chamber 15 to the engine.

The guide member 40 is interposed between the housing main body 11 and the seat member 30. An end of the guide member 40 opposite from the seat member 30 closely contacts the housing main body 11. An end of the seat member 30 on the guide member 40 side defines a seat face 32. The outer peripheral face of the seat member 30 provides an external threaded portion 33. The external threaded portion 33 of the seat member 30 is screwed to an internal threaded portion formed on an inner peripheral face of the cylinder portion 16. Thus, the seat member 30 is fixed to the housing main body 11 through thread connection and the guide member 40 is held between the seat member 30 and the housing main body 11. As a result, the guide member 40 is fixed to the housing main body 11 in a state in which the end of the guide member 40 opposite from the seat member 30 closely contacts the housing main body 11.

The metering valve section 50 has a valve member 51, a spring 52 and an electromagnetic drive section 60. The valve member 51 is located inside the inner peripheral face of the guide member 40 such that the valve member 51 can reciprocate in its axial direction. The valve member 51 is formed substantially in an annular shape. The spring 52 is located on a side of the valve member 51 opposite from the seat member 30. An end of the spring 52 contacts the housing main body 11 and the other end of the spring 52 contacts the valve member 51. The valve member 51 is pressed toward the seat member 30 by the spring 52. An end of the valve member 51 on the seat member 30 side can be seated on the seat face 32. If the valve member 51 is seated on the seat face 32, the space between the pressurization chamber 15 and the fuel chamber 18, i.e., a low-pressure fuel passage, is blocked. The outer peripheral face of the valve member 51 slides on the inner peripheral face of the guide member 40. Thus, axial movement of the valve member 51 is guided by the inner peripheral face of the guide member 40. The guide member 40 provides the groove 41 on it inner peripheral face. Thus, when the valve member 51 separates from the seat member 30, the fuel inside the inner peripheral face of the seat member 30 flows out to the suction passage 22 through the groove 41.

The electromagnetic drive section 60 has a coil 61, a fixed core 62, a movable core 63, a magnetic member 64, a flange 65, a spring 66 and a needle 67. The coil 61 is wound around a resin member 68. If the coil 61 is energized, the coil 61 generates a magnetic field. The fixed core 62 and the movable core 63 are made of a magnetic material. The fixed core 62 is accommodated inside the inner peripheries of the coil 61 and the magnetic member 64. The movable core 63 is located to face the fixed core 62. The movable core 63 is accommodated inside an inner periphery of a cylinder member 69 made of a nonmagnetic material such that the movable core 63 can reciprocate in its axial direction. The cylinder member 69 accommodates the movable core 63 and presses the movable core 63 in a direction opposite to the fixed core 62. Thus, when the coil 61 is de-energized, the fixed core 62 and the movable core 63 are separated from each other.

The flange 65 is mage of a magnetic material. The flange 65 is attached to the cylinder portion 16 of the housing main body 11. Thus, the flange 65 holds the electromagnetic drive section 60 to the housing main body 11 and blocks the end of the cylinder portion 16. The magnetic member 64 covers the outer peripheral face of the coil 61. The magnetic member 64 is made of a magnetic material and magnetically connects the fixed core 62 with the flange 65. The flange 65 is formed with a communication hole 651. Thus, pressure on the introduction passage 21 side of the flange 65 and pressure on the movable core 63 side of the flange 65 are maintained at the same pressure.

The movable core 63 is integrally connected with the needle 67. The end of the needle 67 opposite from the movable core 63 can contact the valve member 51. The pressing force of the spring 66 is greater than the pressing force of the spring 52. Therefore, when the coil 61 is de-energized, the needle 67 integrated with the movable core 63 moves toward the valve member 51 due to the pressing force of the spring 66. At that time, the valve member 51 is separated from the seat member 30.

The discharge section 70 is integrally formed with the housing main body 11 and radially protrudes from the housing main body 11. The discharge section 70 provides the discharge passage 23 inside. The discharge passage 23 connects the pressurization chamber 15 with an outside. The end of the discharge section 70 opposite from the pressurization chamber 15 provides a fuel outlet. The discharge section 70 has a discharge valve 80 for allowing and interrupting the discharge of the fuel pressurized in the pressurization chamber 15. The discharge valve 80 has a spring seat member 81, a ball member 82 as a valve member and a spring 83. The spring seat member 81 is located in the discharge passage 23 provided by the housing main body 11. An end of the spring 83 contacts the spring seat member 81 and the other end contacts the ball member 82. The ball member 82 is pressed toward a valve seat 84, which is defined by the housing main body 11, by a pressing force of the spring 83. The ball member 82 blocks the discharge passage 23 if the ball member 82 is seated on the valve seat 84. The ball member 82 opens the discharge passage 23 if the ball member 82 is separated from the valve seat 84.

A ring 85 as an engaging member is provided on the spring seat member 81 on a side opposite from the pressurization chamber 15. For example, the ring 85 is an E-ring. The ring 85 can extend and contract by elastic deformation in the radial direction of the discharge passage 23. The ring 85 is fitted into a groove 19 of the housing main body 11 and is fixed to the housing main body 11. If the ring 85 is fixed to the housing main body 11, the ring 85 restricts the movement of the spring seat member 81. The spring seat member 81 is pressed toward the ring 85 by the pressure of the fuel that is pressurized in the pressurization chamber 15 and that flows through the discharge passage 23. Since the ring 85 holds the end of the spring seat member 81 on a side opposite from the pressurization chamber 15, the movement of the spring seat member 81 in the axial direction of the discharge passage 23 is restricted. Thus, the spring seat member 81 is held to the housing main body 11 by a simple structure. Alternatively, the spring seat member 81 may be fixed to the housing main body 11 by press-fitting the spring seat member 81 into an inside of the discharge passage 23 defined by the housing main body 11, for example.

The spring seat member 81 has a stopper 86 protruding toward the pressurization chamber 15 from the end of the spring seat member 81 on the pressurization chamber 15 side. The stopper 86 can contact the ball member 82. When the ball member 82 moves away from the valve seat 84, the movement of the ball member 82 is restricted by the contact between the ball member 82 and the stopper 86. Thus, the excessive movement of the ball member 82 is prevented, so reliable operation of the discharge valve 80 is ensured.

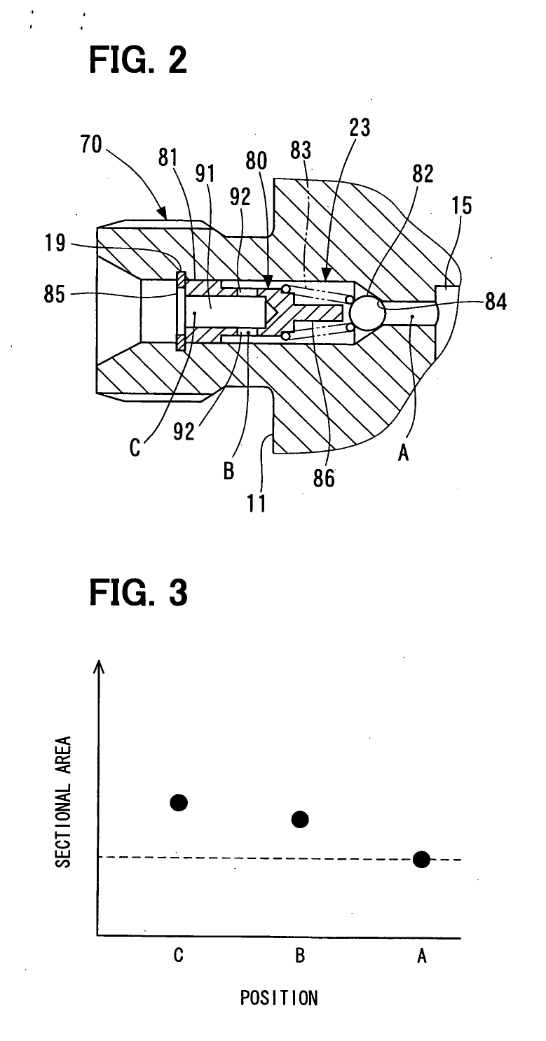

The spring seat member 81 is formed in the shape of a cylinder, whose end on the pressurization chamber 15 side is closed as shown in FIG. 2. Thus, the spring seat member 81 provides a first passage 91 inside. The first passage 91 extends from the end of the spring seat member 81 on a side opposite from the pressurization chamber 15 to a middle of the spring seat member 81 in the axial direction. The spring seat member 81 is formed with a second passage 92 radially penetrating through a side wall of the spring seat member 81 providing the first passage 91. The second passage 92 connects the outer peripheral face of the spring seat member 81 with the first passage 91.

If the fuel pressure in the pressurization chamber 15 increases, the force applied to the ball member 82 by the fuel on the pressurization chamber 15 side increases. The ball member 82 separates from the valve seat 84 if the force applied to the ball member 82 by the fuel on the pressurization chamber 15 side exceeds a summation of the pressing force of the spring 83 and the force of the fuel downstream of the valve seat 84, i.e., the force of the fuel in a delivery pipe (not shown) applied to the ball member 82. Thus, the fuel discharged from the pressurization chamber 15 passes through the space between the ball member 82 and the valve seat 84 and is discharged to the outside of the high-pressure fuel pump 10 through the second passage 92 and the first passage 91. Thus, the space between the ball member 82 and the valve seat 84, where the fuel discharged from the pressurization chamber 15 flows, and the first and second passages 91, 92 provided by the spring seat member 81 provide a part of the discharge passage 23.

If the fuel pressure in the pressurization chamber 15 decreases, the force applied to the ball member 82 by the fuel on the pressurization chamber 15 side decreases. The ball member 82 is seated on the valve seat 84 if the force applied to the ball member 82 by the fuel on the pressurization chamber 15 side becomes smaller than the summation of the pressing force of the spring 83 and the force of the fuel downstream of the valve seat 84, i.e., the force of the fuel in the delivery pipe applied to the ball member 82. Thus, the discharge section 70 functions as a check valve for allowing and interrupting the fuel discharge from the pressurization chamber 15.

As shown in FIG. 3, the sectional area of the discharge passage 23 is small on the pressurization chamber 15 side and increases with distance from the pressurization chamber 15. Among a position A of the discharge passage 23 on the pressurization chamber 15 side of the valve seat 84, a position B of the second passage 92 provided by the spring seat member 81 and a position C of the first passage 91 provided by the spring seat member 81, the sectional area of the discharge passage 23 at the position A is the smallest and the sectional area of the first passage 91 at the position C is the largest. Accordingly, the fuel pressurized in the pressurization chamber 15 is discharged to the outside of the high-pressure fuel pump 10 without being squeezed in the discharge passage 23. Accordingly, pressure loss of the fuel discharged from the pressurization chamber 15 can be reduced.

Next, an operation of the high-pressure fuel pump 10 having the above-described structure will be explained.

(I) Suction Stroke:

The energization of the coil 61 is stopped when the plunger 13 moves downward in FIG. 1. Therefore, the valve member 51 is pressed toward the pressurization chamber 15 by the needle 67 integrated with the movable core 63 pressed by the spring 66. As a result, the valve member 51 is separated from the seat face 32 of the seat member 30. The pressure in the pressurization chamber 15 decreases when the plunger 13 moves downward in FIG. 1. Therefore, the force applied to the valve member 51 by the fuel on the seat member 30 side becomes greater than the force applied to the valve member 51 by the fuel on the pressurization chamber 15 side. As a result, the valve member 51 receives a force for separating from the seat face 32, so the valve member 51 separates from the seat face 32. Thus, the fuel chamber 18 communicates with the pressurization chamber 15 through the introduction passage 21, the communication hole section 20, the communication hole 31 of the seat member 30, the groove 41 and the suction passage 22. Accordingly, the fuel in the fuel chamber 18 is suctioned into the pressurization chamber 15.

(II) Return Stroke:

The fuel pressure in the pressurization chamber 15 increases when the plunger 13 ascends from a bottom dead center toward a top dead center. At that time, the valve member 51 is applied with a force for seating the valve member 51 on the seat face 32 by the fuel on the pressurization chamber 15 side. However, when the coil 61 is de-energized, the needle 67 protrudes toward the pressurization chamber 15 side, i.e., the valve member 51 side, further than the seat face 32 due to the pressing force of the spring 66. Accordingly, the movement of the valve member 51 toward the seat face 32 is restricted by the contact between the valve member 51 and the needle 67. As a result, the valve member 51 maintains a separated state from the seat face 32 while the coil 61 is de-energized. Thus, the fuel in the pressurization chamber 15 is returned to the fuel chamber 18 through the suction passage 22, the groove 41, the communication hole 31, the communication hole section 20 and the introduction passage 21 due to the ascent of the plunger 13 contrary to the case where the fuel is suctioned from the fuel chamber 18 into the pressurization chamber 15.

(III) Pressurization Stroke:

If the coil 61 is energized during the return stroke, the magnetic field generated by the coil 61 makes a magnetic circuit through the fixed core 62, the magnetic member 64, the flange 65 and the movable core 63. Thus, a magnetic attraction is generated between the fixed core 62 and the movable core 63 separated from each other. The movable core 63 moves toward the fixed core 62 if the magnetic attraction generated between the fixed core 62 and the movable core 63 exceeds the pressing force of the spring 66. Accordingly, the needle 67 integrated with the movable core 63 also moves toward the fixed core 62. If the needle 67 moves toward the fixed core 62, the valve member 51 and the needle 67 separate from each other, so the valve member 51 does not receive a force from the needle 67. As a result, the valve member 51 moves toward the seat face 32 due to the pressing force of the spring 52 and the force applied by the fuel on the pressurization chamber 15 side.

The communication between the suction passage 22 and the communication hole 31 is broken if the valve member 51 moves toward the seat face 32 and the valve member 51 is seated on the seat face 32. Thus, the return stroke for returning the fuel from the pressurization chamber 15 to the fuel chamber 18 ends. The communication between the pressurization chamber 15 and the fuel chamber 18 is broken when the plunger 13 ascends. Thus, the fuel amount returned from the pressurization chamber 15 to the fuel chamber 18 is regulated. As a result, the fuel amount pressurized in the pressurization chamber 15 is decided.

The fuel pressure in the pressurization chamber 15 increases if the plunger 13 advances further toward the top dead center while the communication between the pressurization chamber 15 and the fuel chamber 18 is broken. If the fuel pressure in the pressurization chamber 15 becomes equal to or higher than a predetermined pressure, the ball member 82 separates from the valve seat 84 against the pressing force of the spring 83 of the discharge valve 80 and the force of the fuel downstream of the valve seat 84, i.e., the force applied by the fuel in the delivery pipe. Thus, the discharge valve 80 is opened, and the fuel pressurized in the pressurization chamber 15 is discharged from the high-pressure fuel pump 10 through the discharge passage 23. The fuel discharged from the high-pressure fuel pump 10 is supplied to the injector through the delivery pipe. At that time, the needle 67 is separated from the valve member 51. Accordingly, even if the valve member 51 receives the force from the fuel on the pressurization chamber 15 side, the force is not transmitted to the needle 67 of the electromagnetic drive section 60.

If the plunger 13 reaches the top dead center, the plunger 13 starts descending in FIG. 1. Thus, the fuel pressure in the pressurization chamber 15 decreases and the energization to the coil 61 is stopped. Accordingly, the valve member 51 separates from the seat face 32 and the fuel is suctioned into the pressurization chamber 15 from the fuel chamber 18.

By repeating the strokes (I) to (III), the high-pressure fuel pump 10 pressurizes and discharges the suctioned fuel. The discharge amount of the fuel is regulated by adjusting the energization timing of the coil 61 of the metering valve section 50.

The energization of the coil 61 may be stopped when the fuel pressure in the pressurization chamber 15 increases to a predetermined value. If the fuel pressure in the pressurization chamber 15 increases, the force applied to the valve member 51 by the fuel on the pressurization chamber 15 side in a direction for seating the valve member 51 on the seat face 32 becomes larger than the force applied to the valve member 51 by the fuel on the communication hole section 20 side in a direction for separating the valve member 51 from the seat face 32. Therefore, even if the energization of the coil 61 is stopped, the valve member 51 maintains a seated state on the seat face 32 of the seat member 30 due to the force applied by the fuel on the pressurization chamber 15 side. Thus, by stopping the energization of the coil 61 at predetermined timing, the power consumption of the electromagnetic drive section 60 can be reduced.

In the above-explained first example embodiment, the discharge valve 80 is provided in the discharge section 70 integrated with the housing main body 11. The spring seat member 81 providing the discharge valve 80 is accommodated in the discharge passage 23 formed in the discharge section 70 of the housing main body 11. The movement of the spring seat member 81 accommodated in the housing main body 11 is restricted by the ring 85, and the spring seat member 81 is held by the housing main body 11. Thus, binding between the housing main body 11 and the discharge section 70 is unnecessary, and a sealing member or the like to be located between the housing main body 11 and the discharge section 70 for preventing the fuel leak is unnecessary. The spring seat member 81 is formed in a cylindrical shape and the first passage 91 and the second passage 92 are provided in the spring seat member 81. Thus, the passage, through which the fuel pressurized in the pressurization chamber 15 flows, is ensured. Therefore, even if the discharge valve 80 is provided in the housing main body 11, the structure of the housing main body 11 and the discharge section 70 can be simplified, and the number of components can be reduced significantly. No structure for binding the housing main body 11 with the discharge section 70 is necessary. Therefore, the size of the housing main body 11 and the discharge section 70 can be reduced, and the body size of the high-pressure fuel pump 10 can be reduced.

In the first example embodiment, the fuel passing through the space between the ball member 82 and the valve seat 84 flows from the outer peripheral side of the spring seat member 81 into the second passage 92 through the outer peripheral side of the spring 83. Thus, the flow of the fuel in the discharge passage 23 can be ensured even if the spiral portions of the spring 83 closely contact each other due to the movement of the ball member 82. Accordingly, the pressing force of the spring 83 can be reduced and the fuel pressure at the valve opening of the discharge valve 80 can be reduced.

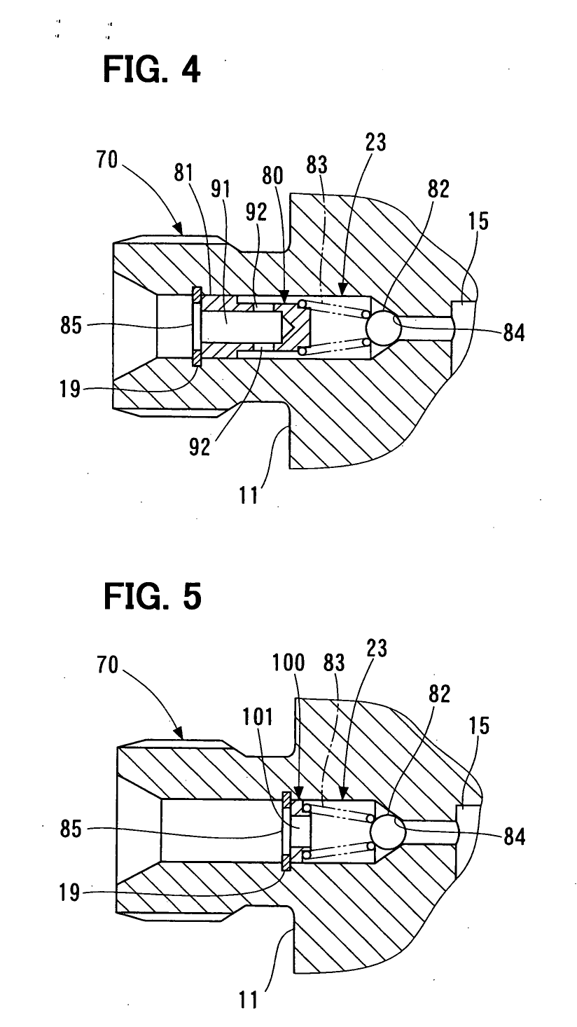

Next, a discharge section of a high-pressure fuel pump according to a second example embodiment of the present invention will be described in reference to FIG. 4. As shown in FIG. 4, the spring seat member 81 according to the second example embodiment is not provided with a portion corresponding to the stopper according to the first example embodiment. Even though the pressing force of the spring 83 has to be increased to prevent excessive movement of the ball member 82 and to ensure reliable operation of the ball member 82, the shape of the spring seat member 81 can be simplified in the present embodiment.

Next, a discharge section of a high-pressure fuel pump according to a third example embodiment of the present invention will be explained in reference to FIG. 5. In the third example embodiment, as shown in FIG. 5, a spring seat member 100 is different from the spring seat member according to the first example embodiment. In the third example embodiment, the spring seat member 100 is formed in a cylindrical shape. Thus, the spring seat member 100 is formed with a fuel passage 101 penetrating through the inside of the spring seat member 100 in the axial direction. An end of the spring 83 on a side opposite from the ball member 82 contacts an end of the spring seat member 100 on the pressurization chamber 15 side. The spring seat member 100 is held by the ring 85 to the housing main body 11.

In the third example embodiment, it is difficult to ensure the space, through which the fuel can pass, if the spring 83 is compressed by the movement of the ball member 82. Therefore, the pressing force of the spring 83 has to be increased to prevent close contact of the spring 83 due to the movement of the ball member 82. Thus, the pressing force of the spring 83 has to be increased in the third example embodiment. However, the discharge passage 23 and the fuel passage 101 are positioned on the same straight line. Accordingly, pressure loss of the fuel discharged from the pressurization chamber 15 through the discharge passage 23 and the fuel passage 101 can be reduced. The sectional area of the spring seat member 100 on a side opposite from the pressurization chamber 15 is larger than the sectional area of the fuel passage 101. Therefore, the flow of the fuel is not squeezed by the spring seat member 100, so the pressure loss of the discharged fuel can be reduced.

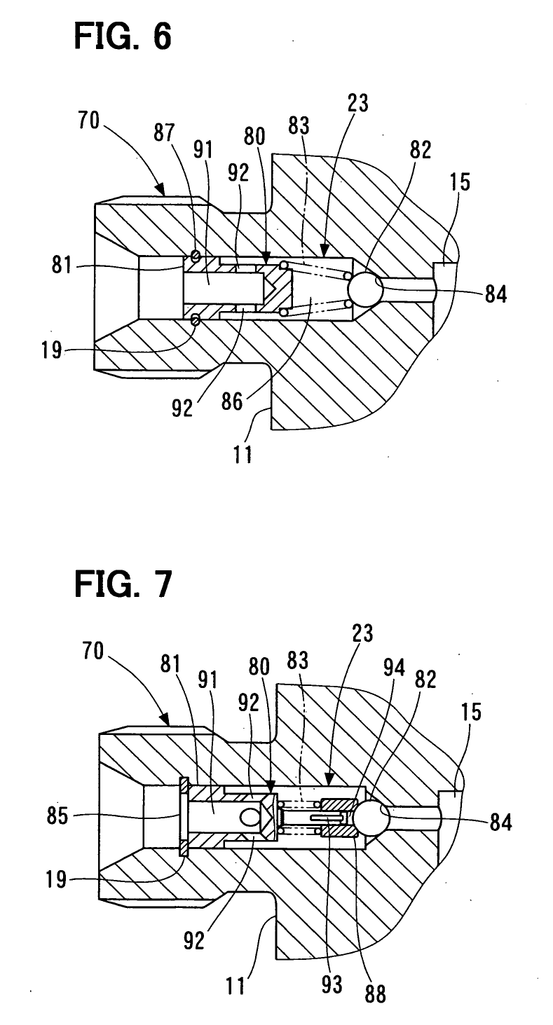

Next, a discharge section of a high-pressure fuel pump according to a fourth example embodiment of the present invention will be explained in reference to FIG. 6. The spring seat member 81 according to the present embodiment is not provided with a portion corresponding to the stopper like the second example embodiment. In the present embodiment, the spring seat member 81 is held to the housing main body 11 by a C-shaped ring 87 instead of the ring according to the first example embodiment. The ring 87 can extend and contract in the radial direction of the discharge passage 23 like the E-ring according to the first example embodiment. The ring 87 exerts a force for enlarging its diameter radially outward. By attaching the ring 87 to the outer peripheral face of the spring seat member 81 and by inserting the spring seat member 81 into the discharge passage 23 of the housing main body 11, the ring 87 fits into the groove 19 by its elastic force. Thus, the spring seat member 81 can be held to the housing main body 11 by a simple structure.

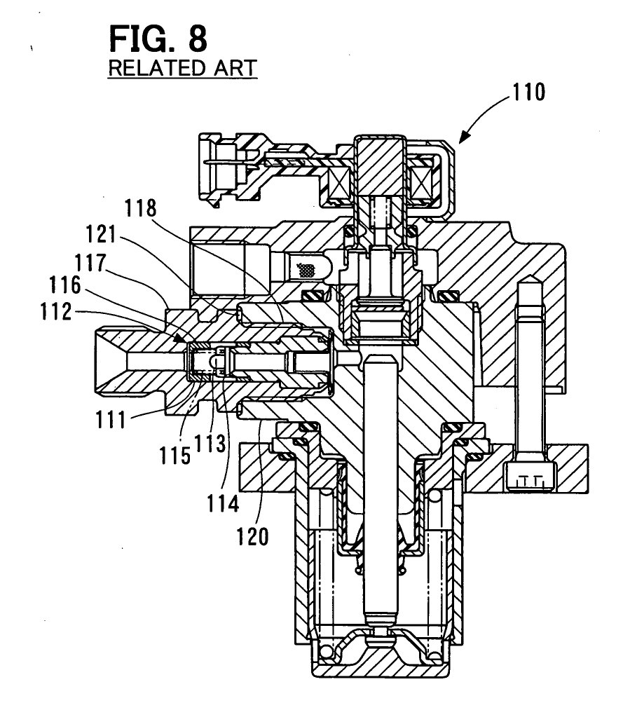

Next, a discharge section of a high-pressure fuel pump according to a fifth example embodiment of the present invention will be explained in reference to FIG. 7. The spring seat member 81 of the discharge valve 80 according to the present embodiment has the stopper 86 like the first example embodiment. The stopper 86 protrudes from the spring seat member 81 toward the pressurization chamber 15. The stopper 86 can contact the ball member 82. The movement of the ball member 82 is restricted by the contact between the ball member 82 and the tip end of the stopper 86.

The discharge valve 80 according to the present embodiment has a guide member 88. The guide member 88 is formed in a cylindrical shape and is provided on the outer peripheral face of the stopper 86. The cylindrical guide member 88 can slide on the stopper 86. Thus, the guide member 88 moves on the outer peripheral face of the stopper 86 in the axial direction of the stopper 86. An end of the guide member 88 on a side opposite from the ring 85 contacts the ball member 82. An axial end of the spring 83 contacts the base of the stopper 86 of the spring seat member 81 and the other axial end of the spring 83 contacts the guide member 88. Thus, the spring 83 presses the ball member 82 toward the valve seat 84 through the guide member 88.

The ball member 82 partly enters the inner peripheral side of the cylindrical guide member 88. Thus, the ball member 82 moves with the guide member 88 when the ball member 82 is seated on the valve seat 84 or is separated from the valve seat 84. The guide member 88 slides on the outer peripheral face of the stopper 86. Therefore, the ball member 82 moves in the axial direction of the stopper 86 while being held by the guide member 88. As a result, vibration of the ball member 82 is reduced by the guide member 88 when the ball member 82 is seated on the valve seat 84 or is separated from the valve seat 84. Thus, the ball member 82 moves stably and the discharge flow rate from the discharge valve 80 is stabilized when the discharge valve 80 opens. The vibration of the spring 83 pressing the ball member 82 is also reduced. As a result, durability of the spring 83 is improved, so the reliability is improved.

The stopper 86 is formed with a concave portion 93 defining a communication portion. The concave portion 93 is formed radially inward from the outer peripheral face of the stopper 86. Thus, the communication portion, through which the fuel flows, is formed between the stopper 86 and the guide member 88 at a position corresponding to the concave portion 93. A closed space 94 is defined by the tip end of the stopper 86, the inner peripheral face of the guide member 88 and the ball member 82 since the guide member 88 is provided on the outer peripheral face of the stopper 86. The high-pressure fuel pressurized in the pressurization chamber 15 flows into the space 94 through the clearance between the outer wall face of the ball member 82 and the inner wall face of the guide member 88. Accordingly, if the pressure of the fuel flowing into the space 94 increases, the pressing force for pressing the ball member 82 changes and the accuracy of the fuel discharge pressure decreases. Since the concave portion 93 provides the communication portion between the stopper 86 and the guide member 88, the fuel flowing into the space 94 flows out to the second passage 92 through the concave portion 93 as the communication portion. Thus, the fuel flowing into the space 94 is discharged from the space 94.

The concave portion 93 is formed on the stopper 86 to define the space 94. Alternatively, a concave portion may be formed on the inner wall of the guide member 88 to form a communication portion. Instead of forming the concave portion 93 on the stopper 86, the communication portion may be formed by a chamfered portion, for example.

In the fifth example embodiment, the guide member 88 sliding on the stopper 86 is provided. Since the guide member 88 slides on the stopper 86, the discharge valve 80 is unitized by the ball member 82, the guide member 88, the spring 83 and the spring seat member 81. Thus, the respective components constructing the discharge valve 80 can be easily mounted from the end of the housing main body 11 into the discharge passage 23 as a unit.

The above-described multiple embodiments may be applied to the high-pressure fuel pump 10 in combination. In the fifth example embodiment, the guide member 88 slides on the stopper 86. Alternatively, the guide member 88 may hold the ball member 82 by sliding on the inner peripheral wall of the housing main body 11 defining the discharge passage 23.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A high-pressure fuel pump comprising:
a housing formed with a pressurization chamber for pressurizing fuel;
a discharge section integrally formed with the housing for defining a discharge passage inside, through which the fuel pressurized in the pressurization chamber is discharged; and
a discharge valve provided in the discharge section for opening and closing the discharge passage.

2. The high-pressure fuel pump as in claim 1, further comprising:
an engaging member that engages the discharge valve to the discharge section.

3. The high-pressure fuel pump as in claim 2, wherein
the discharge valve includes:
a valve member that is seated on a valve seat defined by the housing or is separated from the valve seat;
a spring that presses the valve member toward the valve seat; and
a spring seat member provided on a side of the valve member opposite from the pressurization chamber, the spring seat member contacting an end of the spring opposite from the valve member, and
the engaging member engages the spring seat member to the housing.

4. The high-pressure fuel pump as in claim 3, wherein
the spring seat member is formed with a first passage extending from an end of the spring seat member opposite from the pressurization chamber to a middle of the spring seat member along an axial direction of the spring seat member and with a second passage that penetrates through a side wall of the spring seat member in a radial direction of the spring seat member and communicates with the first passage.

5. The high-pressure fuel pump as in claim 4, wherein
the first passage has a larger sectional area than the second passage.

6. The high-pressure fuel pump as in claim 4, wherein
the spring seat member has a stopper at an end thereof on the pressurization chamber side for restricting movement of the valve member.

7. The high-pressure fuel pump as in claim 3, wherein
the spring seat member is formed with a fuel passage, through which the fuel passing through the discharge passage flows, the fuel passage penetrating through the spring seat member in an axial direction of the spring seat member.

8. The high-pressure fuel pump as in claim 7, wherein
the discharge passage is formed such that a sectional area of the discharge passage on a side of the spring seat member opposite from the pressurization chamber is larger than a sectional area of the fuel passage.

9. The high-pressure fuel pump as in claim 6, further comprising:
a guide member provided around an outer peripheral face of the stopper for holding the valve member on a side opposite from the valve seat.

10. The high-pressure fuel pump as in claim 9, wherein
the guide member is provided such that the guide member can slide on the stopper.

11. The high-pressure fuel pump as in claim 10, wherein
the stopper is formed with a communication portion for connecting a space, which is defined by an end of the stopper on the valve member side, the valve member and the guide member, with a space formed on the outer peripheral face of the stopper.

12. The high-pressure fuel pump as in claim 10, wherein
the guide member is formed with a communication portion for connecting a space, which is defined by an end of the stopper on the valve member side, the valve member and the guide member, with a space formed on the outer peripheral face of the stopper.

13. The high-pressure fuel pump as in claim 9, wherein
the guide member is provided such that the guide member can slide on an inner peripheral wall of the discharge passage.

14. A high-pressure fuel pump comprising:
a housing formed with a pressurization chamber for pressurizing fuel;
a discharge section integrally formed with the housing for defining a discharge passage, through which the fuel pressurized in the pressurization chamber is discharged; and
a discharge valve provided in the discharge section for opening and closing the discharge passage, wherein
the discharge valve includes:
a valve member that is seated on a valve seat defined by the housing or is separated from the valve seat;
a spring seat member provided on a side of the valve member opposite from the pressurization chamber, the spring seat member having a stopper on an end thereof on the pressurization chamber side for restricting movement of the valve member;
a guide member provided around an outer peripheral face of the stopper for holding the valve member on a side opposite from the valve seat; and
a spring for pressing the valve member toward the valve seat through the guide member, the spring provided such that an end of the spring contacts the spring seat member and the other end of the spring contacts the guide member.

15. The high-pressure fuel pump as in claim 14, wherein
the guide member is provided such that the guide member can slide on the stopper.

16. The high-pressure fuel pump as in claim 15, wherein
the stopper is formed with a communication portion for connecting a space, which is defined by an end of the stopper on the valve member side, the valve member and the guide member, with a space formed on the outer peripheral face of the stopper.

17. The high-pressure fuel pump as in claim 15, wherein
the guide member is formed with a communication portion for connecting a space, which is defined by an end of the stopper on the valve member side, the valve member and the guide member, with a space formed on the outer peripheral face of the stopper.

18. The high-pressure fuel pump as in claim 14, wherein
the guide member is provided such that the guide member can slide on an inner peripheral wall of the discharge passage.
